(19) United States
(12) Patent Application Publication
(10) Pub. No.: US 2011/0252435 A1
(43) Pub. Date: Oct. 13, 2011

(54) DISK DRIVE

(76) Inventors: Juhnho Park, Seoul (KR); Heuisik Seo, Seoul (KR); Donghwa Yun, Seoul (KR); Byunghoon Min, Seoul (KR)

(21) Appl. No.: 13/140,667

(22) PCT Filed: Jul. 12, 2010
(86) PCT No.: PCT/KR2010/004508

§ 371 Date: Jun. 17, 2011

(30) Foreign Application Priority Data
Jul. 13, 2009 (KR) 10-2009-0063713
Jan. 8, 2010 (KR) 10-2010-0001887

(51) Int. Cl. G11B 33/02

(52) U.S. Cl. 720/600; G9B/33.002

(57) ABSTRACT

A disk drive integrating an optical disk drive (110) and a solid state disk (40) is provided. The solid state disk (40) is mounted on the exterior of a main chassis (12) of the optical disk drive (110) and connected to a main board (20) of the optical disk drive (110) such that the solid state disk (40) shares an interface (22) of the main board (20). In another implementation, a main board (70) is extended and located in a space corresponding to the bottom of a pick-up base (68) in the inner space (65) of a main chassis (62) and a solid state disk is mounted on the extended main board (70). Accordingly, the solid state disk and the optical disk drive can be mounted together in the existing notebook computer without modifying the interior design of the existing notebook computer to thereby improve portability and user convenience.

### TECHNICAL FIELD

The present invention relates to a disc drive and, more particularly, to a disc drive constructed in such a manner that a solid state disk is mounted in an optical disc drive.

### BACKGROUND ART

A solid state disk or a solid state disk drive SSD is getting the spotlight as an auxiliary memory of computers. The solid state disk is a data storage device which is based on memories such as a flash memory and DDR instead of a hard disk drive.

The solid state disk barely generates heat and noise and is robust to external impacts because the solid state disk does not include a mechanical driver such as a motor which is essential for the hard disk drive. Furthermore, the solid state disk has a data transfer rate, particularly, data access speed, which is much higher than that of the existing hard disk drive. Accordingly, the solid state disk has been mounted in high performance notebook computers in recent years.

FIG. 1 is a plan view showing the interior structure of a conventional optical disk drive mounted in a notebook computer. The conventional optical disk drive includes a main chassis 2 constructing the exterior of the optical disk drive and having a main circuit board 10 mounted therein and a tray 6 which is inserted/ejected into/from the main chassis 2 and loads a disk D.

The tray 6 includes a turntable 7 for fixing the disk D, which is formed at the center of the tray 6 and an optical pick-up 8 for recording a signal on the disk D or reading the recorded signal. The optical pick-up 8 is movable along a pick-up window 8′ formed at the tray 6.

The main board 10 on which various components 11, 14 and 14′ are mounted is set in the inner space 5 of the main chassis 2 and has a rectangular shape. The main board 10 is located above the main chassis 2 on the basis of FIG. 1 such that the main board 10 and the optical pick-up 8 do not interfere with each other. This is because there is no extra space under the optical pick-up 8 when the tray 6 is completely inserted into the inner space 5 of the main chassis 2 so that other components cannot be located under the optical pick-up 8 since the height of the inner space 5 of the main chassis 2 is limited and the optical pick-up 8 has a thickness corresponding to the height of the inner space 5.

Attempts to mount a solid state disk in an optical disk drive while maintaining the size of a main chassis of the optical disk drive have been made. However, it was difficult to set the solid state disk in the optical disk drive because the size of the optical disk drive was limited as described above.

### DISCLOSURE OF INVENTION

### Technical Problem

An object of the present invention is to combine a solid state disk with an optical disk drive without changing inner space division of a notebook computer.

Another object of the present invention is to integrate a solid state disk into an optical disk drive mounted in a notebook computer without changing the size of the optical disk drive and the structure of a main chassis of the optical disk drive.

### Solution to Problem

According to an aspect of the present invention, there is provided a disk drive comprising: a main chassis having a cable slot formed at one side thereof; a main board mounted in the main chassis, mounting an interface for transmitting/receiving data to/from a computer and processing operating signals of an optical disk drive; and a solid state disk selectively mounted on one side of the exterior of the main chassis, wherein the main board and the solid state disk are connected to each other by a cable passing through the cable slot such that the solid state disk shares the interface of the main board.

In an embodiment, the solid state disk may be fixed onto a mounting part formed at one side of the bottom face of the main chassis.

In an embodiment, the disk drive may further comprise a cover case combined with the main chassis to protect the solid state disk and cover the mounting part.

In an embodiment, a plurality of cover fixing bosses combined with bolts for combining the main chassis with the cover case may be formed on the mounting part and one of the cover fixing bosses may penetrate one side of the solid state disk to guide a fixing position of the solid state disk.

In an embodiment, a board fixing boss combined with a bolt for fixing the solid state disk may be formed on the mounting part.

In an embodiment, the cover case may be combined with the main chassis to accomplish a rectangular exterior of the disk drive.

In an embodiment, the cover case may have a cover covering a corner of the solid state disk and a cover combining boss for combining the cover with the solid state disk may be formed at the inner side of the cover.

In an embodiment, a tray on which a disk is mounted may be provided on one side of the main chassis such that the tray is inserted/ejected into/from the main chassis. The tray may comprise a movable optical pick-up for recording a signal on the disk or reading the recorded signal.

According to another aspect of the present invention, there is provided a disk drive comprising: a main chassis having an inner space; a tray provided in the inner space of the main chassis such that the tray is inserted/ejected into/from the inner space of the main chassis and having a turntable on which a disk is mounted; a pick-up base included in the tray and having a size smaller than the main chassis; and a main board mounted in the inner space, transmitting/receiving signals or data to/from a computer and processing operation signals, wherein a part of the main board is placed in an extra space under the pick-up base in the inner space of the main chassis and at least one memory chip constructing a solid state disk is mounted on the part of the main board.

In an embodiment, the main board may comprise a main driving part located at the back of the main chassis and a sub-disk part extended from one side of the main driving part to the front of the main chassis and having the memory chip mounted thereon.

In an embodiment, a combining bracket for combining the sub-disk part with the main chassis may be combined with the sub-disk part and the combining bracket may include a fixed part fixed to the bottom face of the sub-disk part and a combining part that is protruded from the fixed part to the front of the sub-disk part and has a through-hole into which a bolt is inserted.

In an embodiment, the thickness of the main chassis may be 12.7 mm and the thickness of the pick-up base may be 9.7 mm.

### Advantageous Effects of Invention

According to the present invention, the solid state disk can be selectively mounted in the notebook computer without changing the interior design of the notebook computer, and thus a conventional notebook computer assembly and production line can be maintained to remarkably decrease the cost.

Furthermore, there is no need for the solid state disk to include an additional interface for data communication, and thus the size of the solid state disk is reduced or the configuration of the optical disk drive is simplified to achieve a compact disk drive.

Moreover, the disk drive can accommodate the solid state disk even without modifying the main chassis of the disk drive, and thus portability and user convenience can be improved.

### BRIEF DESCRIPTION OF DRAWINGS

FIG. 1 is a plan view showing the interior structure of a conventional optical disk drive mounted in notebook computers;

FIG. 2 is an exploded perspective view of a disk drive according to an embodiment of the present invention;

FIG. 3 is a plan view showing the interior structure of the disk drive shown in FIG. 2;

FIG. 4 is a perspective view showing an assembled state of the disk drive shown in FIG. 2;

FIG. 5 is a cross-sectional view of a disk drive according to another embodiment of the present invention;

FIG. 6 is a plan view showing the interior structure of the disk drive shown in FIG. 5; and

FIG. 7 is a perspective view of a main board of the disk drive shown in FIG. 5.

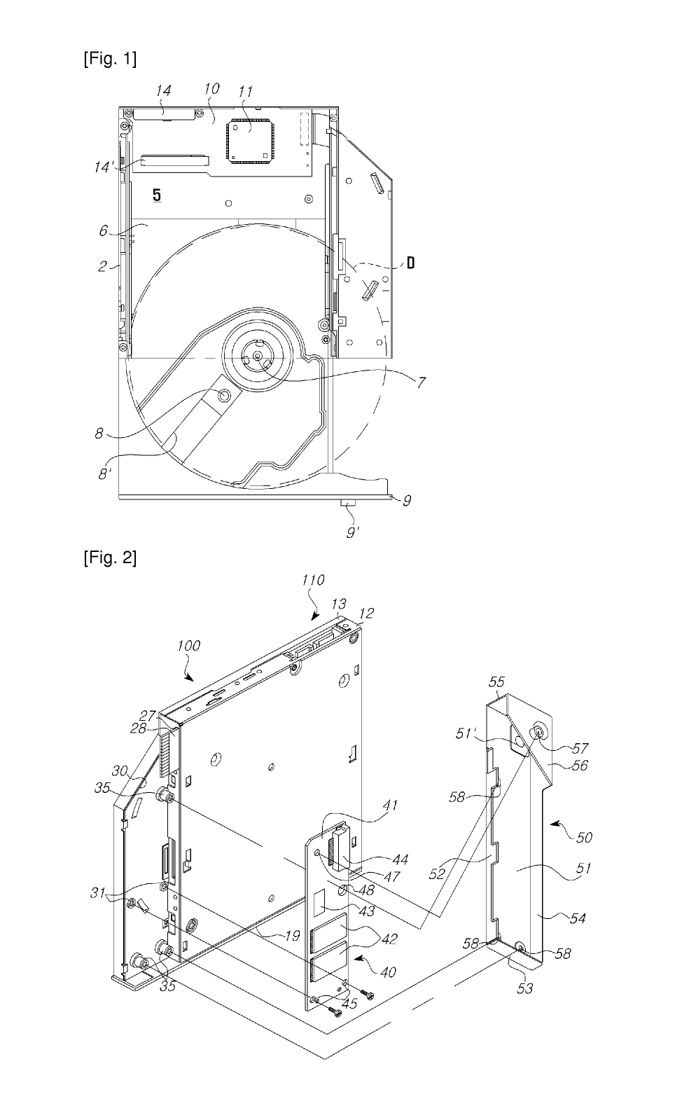

### BEST MODE FOR CARRYING OUT THE INVENTION

The present invention will now be described more fully with reference to the accompanying drawings, in which exemplary embodiments of the invention are shown.

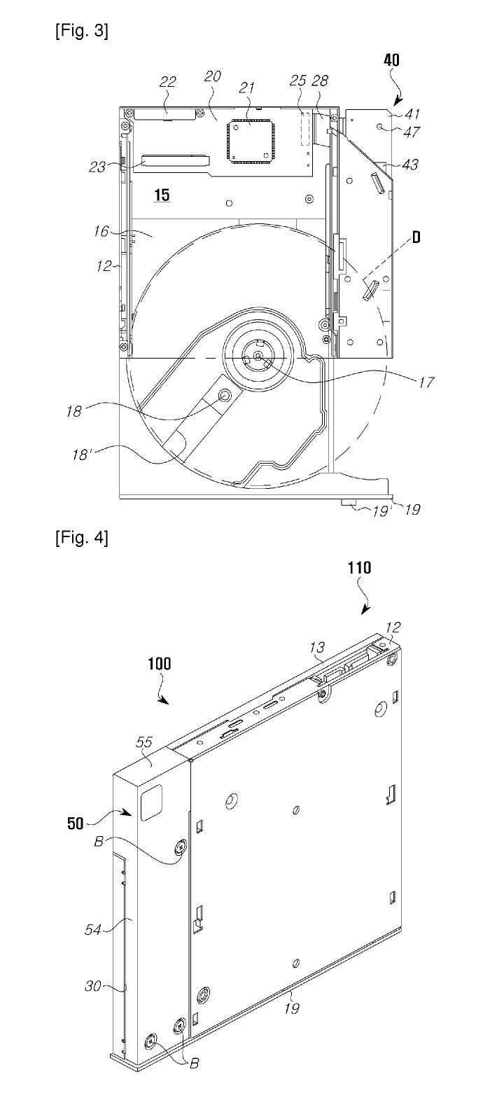

FIG. 2 is an exploded perspective view of a disk drive according to an embodiment of the present invention, FIG. 3 is a plan view showing the interior structure of the disk drive shown in FIG. 2, and FIG. 4 is a perspective view showing an assembled state of the disk drive shown in FIG. 2.

The disk drive according to an embodiment of the present invention is constructed in such a manner that a solid state disk 40 is integrated into an optical disk drive 110. More specifically, the solid state disk 40 is mounted on the exterior of a main chassis 12 of the optical disk drive 110 and connected to a main board 20 of the optical disk drive 110 such that the solid state disk 40 can share an interface 22 (shown in FIG. 3) of the main board 20.

The main chassis 12 forms the exterior of the optical disk drive 110. The main chassis 12 is combined with an upper cover 13 for covering an open side of the main chassis 12. A movable tray 16 is provided in the inner space 15 of the main chassis 12, as shown in FIG. 3. The tray 16 includes a component for driving an optical disk D and a component for recording a signal on the disk D or reading the recorded signal from the disk D.

Specifically, the tray 16 includes a turntable 17 which loads and rotates the disk D and is formed at the center of the tray 16 and an optical pick-up 18 which records a signal on the disk D or reads the recorded signal from the disk D and is movable along a pick-up window 18′ formed in the tray 16.

A front plate 19 is attached to the front side of the tray 16. A switch knob 19′ to which an instruction for inserting/ejecting the tray 16 into/from the optical disk drive 110 is applied is provided on the front side of the front plate 19 in an exposed manner.

The main board 20 on which a main controller 21 for controlling the operation of the optical disk drive 110 is mounted is provided in the inner space 15 of the main chassis 12. The interface 22 for connecting the optical disk drive 110 to a notebook computer (not shown) and a tray connector 23 for connecting the tray 16 to the main board 20 are mounted on one side of the main board 20. The tray connector 23 is connected to a tray cable (not shown) having a sufficient length that allows the tray 16 to move.

A board connector 25 is mounted on the other side of the main board 20, which is opposite to the side on which the main controller 21 is mounted. The board connector 25 is connected to one end of a flexible cable 28 used to connect a board 41 of the solid state disk 40 to the main board 20.

A cable slot 27 is formed on one side of the main chassis 12, as shown in FIG. 2. The cable slot 27 is an opening through which the flexible cable 28 for connecting the main board 20 mounted in the main chassis 12 to the board 41 of the solid state disk 40 passes.

A mounting part 30 on which the solid state disk 40 is mounted is formed on one outer side of the main chassis 12. The mounting part 30 corresponds to the bottom face of the main chassis 12 which faces the bottom face of the notebook computer (not shown) when the main chassis 12 is mounted in the notebook computer. A predetermined space is formed between the mounting part 30 and the bottom face of the notebook computer.

The mounting part 30 corresponds to the bottom face of the main chassis 12 among parts of the main chassis 12 other than the tray mounting part of the main chassis 12. A part of the disk D mounted on the tray 16 is located on the side opposite to the mounting part 30.

The solid state disk 40 is fixed onto the mounting part 30. The solid state disk 40 is a data storage device which stores large capacity data using a flash memory. The solid state disk 40 includes the board 41, a controller 43 and at least one memory chip 42.

A pair of board fixing bosses 31 are formed at the middle part of the mounting part 30. The board fixing bosses 31 are combined with bolts B for fixing the board 41 of the solid state disk 40.

In addition, cover fixing bosses 35 for fixing a cover case 50 that covers the mounting part 40 and protects the solid state disk 40 are formed on the mounting part 30. The cover fixing bosses 35 are combined with bolts B for fixing the cover case 50.

The memory chip 42 is mounted on one side of the board 41 of the solid state disk 40. The number of memory chip 42 may increase according to the size of data stored in the memory chip 42. The controller 43 for controlling the memory chip 42 is mounted on the board 41. A board connector 44 is mounted on the side of the board 41, opposite to the side on which the controller 43 is mounted, and connected with the flexible cable 28 for connecting the solid state disk 40 to the optical disk drive 110.

A pair of board fixing holes 45 corresponding to the board fixing bosses 31 are formed in the board 41 of the solid state disk 40. In addition, a cover combining hole 47 corresponding to a cover combining boss 57 formed at one corner of the cover case 50 is formed in the board 41. A through-hole 48 through which one of the cover fixing bosses 35 penetrates the board 41 is formed in the board 41.

The main chassis 12 is combined with the cover case 50. The cover case 50 covers the mounting part 30 and protects the solid state disk 40 mounted on the mounting part 30. As the cover case 50 is combined with the main chassis 12, the rectangular shape of the disk drive is accomplished.

The bottom face 51 of the cover case 50 and the bottom face of the main chassis 12 form a continuous surface in contact with the bottom face of the notebook computer in which the disk drive is mounted.

A combining hole 51′ corresponding to the cover combining boss 57 of a cover 56, which will be described later, is formed at the bottom face 51 of the cover case 50.

A contact face 52 of the cover case 50 comes into contact with one side of the main chassis 12, which faces the mounting part 30. The front face 53 of the cover case 50 is in close contact with the front plate 19 and the outer face of the cover case 50 forms a part of the outer face of the disk drive. The rear face 55 of the cover case 50 and the rear face of the main chassis 12 form a continuous surface.

The cover 56 is formed at the corner of the cover case 50, at which the rear side 55 and the outer face 54 of the cover case 50 are connected to each other. The cover 56 covers a corner of the board 41, which projected from the mounting part 30. The cover combining boss 57 is formed in a position corresponding to the cover combining hole 47 of the board 41 in the cover 56 and protruded inward. The cover 56 and the board 41 are combined with each other by a bolt B that combines the cover combining boss 57 and the cover combining hole 47 of the board 41. Bolt holes 58 corresponding to the cover fixing bosses 35 are formed at the bottom face 51 of the cover case 50.

A disk drive assembling process and driving of the solid state disk 40 according to the present invention will now be explained.

One end of the flexible cable 28 is inserted into the board connector 25 of the main board 20 fixed to the main chassis 12. In this state, the other end of the flexible cable 28 is projected to the outside of the main chassis 12 through the cable slot 27.

Then, the board 41 of the solid state disk 40 is fixed onto the mounting part 30. To achieve this, the cover fixing boss 35 passes through the through-hole 48 to confirm a mounting position of the board 41, and then the board 41 is temporarily combined with the mounting part 30. In this state, bolts B pass through the board fixing holes 45 and the board fixing bosses 31 to fix the board 41 onto the mounting part 30.

Here, the other end of the flexible cable 28, projected from the cable slot 27, is inserted into the board connector 44 of the board 41. Accordingly, the main board 20 and the board 41 of the solid state disk 40 are electrically connected to each other by the flexible cable 28.

Particularly, the board 41 of the solid state disk 40 shares the interface 22 mounted on the main board 20 according to the flexible cable 28. That is, the solid state disk 40 can perform data communication with the notebook computer or an external device through the interface 22 mounted on the main board 20.

Other components for driving the optical disk drive, for example, the tray 16 is set in the main chassis 12 such that the tray 16 is movable. The front plate 19 is combined with one side of the tray 16 to construct the front side of the disk drive 100.

Finally, the cover case 50 is combined with the main chassis 12 by combining the cover fixing bosses 35 with bolts. The cover case 50 protects the board 41 of the solid state disk 40. Particularly, the cover 56 covers the corner of the board 41, which is projected from the mounting part 30. The cover combining boss 57 that is projected to the inside of the cover 56 and corresponds to the cover combining hole 47 of the board 41 is combined with the bolt B to combine the cover case 50 with the board 41. When the cover case 50 is combined with the main chassis 12, the disk drive 100 having a rectangular shape is accomplished.

For reference, an optical disk drive mounting space is provided in the existing notebook computer. The present invention provides the disk drive 100 with the solid state disk 40 mounted on the outer side of the main chassis 12, which is opposite to the side on which the components of the optical disk drive 110 are mounted. Accordingly, the disk drive 100 including the solid state disk 40 can be mounted in the notebook computer without modifying the interior design of the notebook computer.

According to the present invention, the disk drive 100 with the solid state disk 40 mounted on the mounting part 30 of the main channel 12 may be mounted in a high performance notebook computer that requires the solid state disk 40 and the disk drive 100 having no solid state disk may be mounted in a general notebook computer that does not requires the solid state disk 40. In both cases, there is no need to modify the interior designs of the notebook computers to mount the disk drive 100 including the solid state disk 40 if an optical disk drive can be mounted in the notebook computers.

The solid state disk 40 and the main board 20 of the optical disk drive 110 are connected to each other by the flexible cable 28 such that the solid state disk 40 performs data communication with an external device using the interface 22 of the main board 20. Accordingly, there is no need for the solid state disk 40 to be provided with an additional interface because the solid state disk 40 shares the interface 22 of the main board 20 of the optical disk drive 110, and thus the size of the board 41 of the solid state disk 40 can be reduced to decrease the size of the disk drive 100 and simplify the configuration of the disk drive 100.

A disk drive according to another embodiment of the present invention will be explained with reference to the attached drawings.

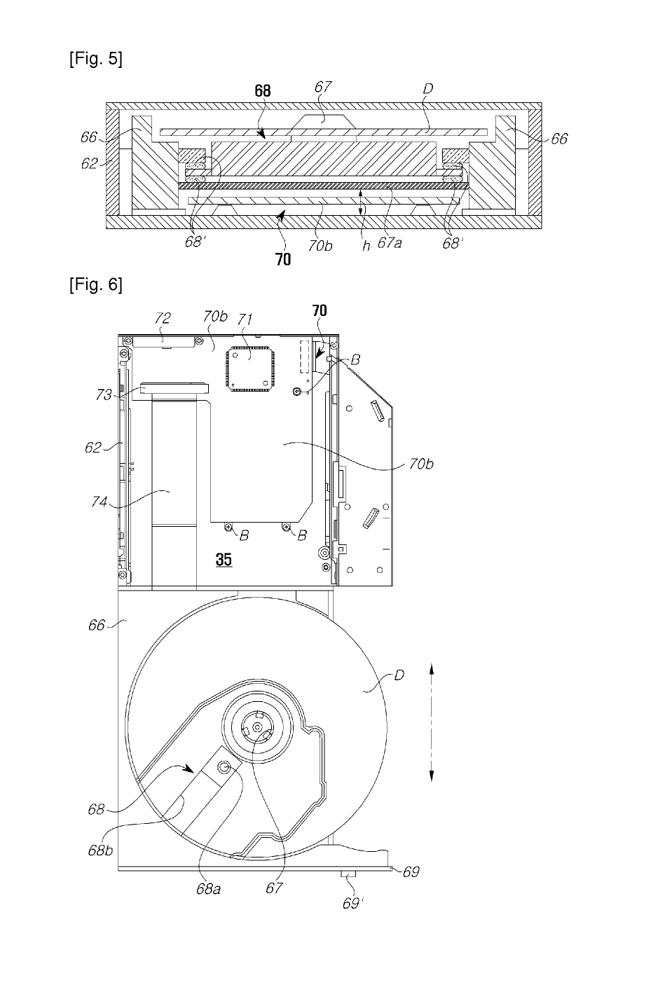

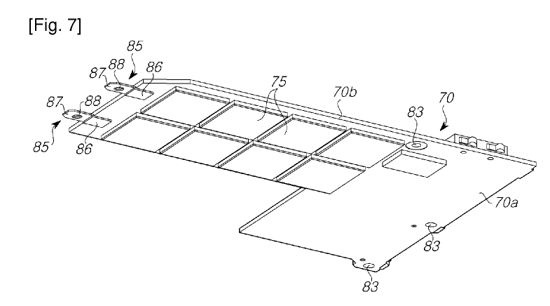

FIG. 5 is a cross-sectional view of the disk drive according to another embodiment of the present invention, FIG. 6 is a plan view showing the interior structure of the disk drive shown in FIG. 5, and FIG. 7 is a perspective view of a main board of the disk drive shown in FIG. 5.

The size of a main chassis 62 and the size of a pick-up base 68 are different from each other such that a space corresponding to the bottom of the pick-up base 68 among the inner space 65 of the main chassis 62 is secured, a main board 70 is extended and located in the secured space and a memory chip 75 comprising a solid state disk is mounted on the extended main board 70.

Specifically, the main chassis 62 forms the exterior of the disk drive, as shown in FIGS. 5 and 6. While disk drives having various sizes are mounted in notebook computers, the disk drive in the current embodiment has a thickness of 12.7 mm. The main chassis 62 has the inner space 65 in which a movable tray 66 is mounted. The tray 66 can be moved in the direction indicated by an arrow shown in FIG. 6.

The tray 66 generally includes a component for driving a disk D and a component for recording a signal on the disk D or reading the recorded signal. Specifically, the tray 66 includes a turntable 67 that loads and rotates the disk D and is formed at the center of the tray 66 and the pick-up base 68 that records a signal on the disk D or reads the recorded signal. The pick-up base 68 is supported by a damper 68′ formed at the tray 66, as shown in FIG. 5. In addition, an optical pick-up 68a provided on the pick-up base 68 is movable along a pick-up window 68b formed in the tray 66, as shown in FIG. 6.

While pick-up bases having various sizes are mounted in notebook computers, the pick-up base 68 having a thickness of 9.7 mm, which is thinner than the main chassis 62, may be used in the current embodiment. When the 9.7 mm pick-up base 68 is mounted in the 12.7 mm main chassis 62, a predetermined extra space having a predetermined height h is formed between a pick-up base cover 67a provided under the pick-up base 68 and the main chassis 62, as shown in FIG. 5. As the extra space is formed, the main board 70 can be located under the pick-up base cover 67a.

The main board 70 is mounted in the inner space 65 of the main chassis 62 to drive the disk drive and transfer various operating signals. The main board 70 has an ‘L’ shape in the current embodiment. Referring to FIG. 6, the main board 70 includes a main driving part 70a horizontally extended at the back of the main chassis 62 and a sub-disk part 70b extended from one side of the main driving part 70a to the front of the main chassis 62.

The main driving part 70a includes a main controller 71 for controlling the disk drive, an interface 72 for interfacing the disk drive with a notebook computer and a tray connector 73 for connecting the tray 66 with the main board 60, which are mounted on the main driving part 70a. The tray connector 73 is connected to a flexible cable 74 having a sufficient length that allows the tray 66 to move. The main driving part 70a has bolt holes 83 for combining the main driving part 70a with the main chassis 62.

The sub-disk part 70b is extended in parallel with the flexible cable 74. The sub-disk part 70b is mounted in the extra space. At least one memory chip 75 comprising the solid state disk is mounted on the bottom face of the sub-disk part 70b, as shown in FIG. 7.

According to the current embodiment of the invention, since the extra space having the predetermined height h is secured, the main board 70 can be extended and located under the pick-up base 68 and the memory chip 75 can be mounted on the sub-disk part 70b of the extended main board 70 to set the solid state disk in the main chassis 62 of the disk drive without changing the structure of the main chassis 62.

Referring to FIG. 7, combining brackets 85 for fixing the sub-disk part 70b to the main chassis 62 are combined with the front end of the sub-disk part 70b. Each combining bracket 85 includes a fixed part 86 fixed to the bottom face of the sub-disk part 70b and a combining part 87 protruded from the fixed part 86 to the front of the sub-disk part 70b.

The combining part 87 includes a through-hole 88 into which a bolt B is inserted. If a through-hole is directly formed in the sub-disk part 70b and the sub-disk part 70b is combined with the main chassis 62 by combining the through-hole with a bolt, the height of the head of the bolt is added to the thickness of the sub-disk part 70b and the extra space cannot receives this combined part. Accordingly, the combining part 87 is projected to the front of the sub-disk part 70b such that the combining part 87 thinner than the sub-disk part 70b is combined with the bolt B to fix the sub-disk part 70b in the extra space.

A front plate 69 is attached to the front side of the tray 66. A switch knob 69′ receiving an instruction for inserting/ejecting the tray 66 into/from the disk drive is formed on the front plate 69 in an exposed manner.

According to the present invention, the pick-up base 68 smaller than the main chassis 62 is mounted in the main chassis 62, and thus the main board 70 can be extended and located under the pick-up base 68. Accordingly, the memory chip 75 can be mounted on the sub-disk part 70b of the extended main board 70 to set the solid state disk in the main chassis 62 of the disk drive without modifying the structure of the main chassis 62.

While the present invention has been particularly shown and described with reference to exemplary embodiments thereof, it will be understood by those of ordinary skill in the art that various changes in form and details may be made therein without departing from the spirit and scope of the present invention as defined by the following claims.

1-12. (canceled)

13. A disk drive comprising:
a main chassis having a cable slot formed at one side thereof;
a main board mounted in the main chassis, mounting an interface for transmitting/receiving data to/from a computer and processing operating signals of an optical disk drive; and
a solid state disk selectively mounted on one side of the exterior of the main chassis,
wherein the main board and the solid state disk are connected to each other by a cable passing through the cable slot such that the solid state disk shares the interface of the main board.

14. The disk drive of claim 13, wherein the solid state disk is fixed onto a mounting part formed at one side of the bottom face of the main chassis.

15. The disk drive of claim 14, further comprising a cover case combined with the main chassis to protect the solid state disk and cover the mounting part.

16. The disk drive of claim 15, wherein a plurality of cover fixing bosses combined with bolts for combining the main chassis with the cover case are formed on the mounting part and one of the cover fixing bosses penetrates one side of the solid state disk to guide a fixing position of the solid state disk.

17. The disk drive of claim 16, wherein a board fixing boss combined with a bolt for fixing the solid state disk is formed on the mounting part.

18. The disk drive of claim 17, wherein the cover case is combined with the main chassis to accomplish a rectangular exterior of the disk drive.

19. The disk drive of claim 18, wherein the cover case has a cover covering a corner of the solid state disk and a cover combining boss for combining the cover with the solid state disk is formed at the inner side of the cover.

20. The disk drive of claim 13, wherein a tray on which a disk is mounted is provided on one side of the main chassis such that the tray is inserted/ejected into/from the main chassis, the tray comprising a movable optical pick-up for recording a signal on the disk or reading the recorded signal.

21. A disk drive comprising:
a main chassis having an inner space;
a tray provided in the inner space of the main chassis such that the tray is inserted/ejected into/from the inner space of the main chassis and having a turntable on which a disk is mounted;
a pick-up base included in the tray and having a size smaller than the main chassis; and
a main board mounted in the inner space, transmitting/receiving signals or data to/from a computer and processing operation signals,
wherein a part of the main board is placed in an extra space under the pick-up base in the inner space of the main chassis and at least one memory chip constructing a solid state disk is mounted on the part of the main board.

22. The disk drive of claim 21, wherein the main board comprises a main driving part located at the back of the main chassis and a sub-disk part extended from one side of the main driving part to the front of the main chassis and having the memory chip mounted thereon.

23. The disk drive of claim 22, wherein a combining bracket for combining the sub-disk part with the main chassis is combined with the sub-disk part and the combining bracket comprises a fixed part fixed to the bottom face of the sub-disk part and a combining part that is protruded from the fixed part to the front of the sub-disk part and has a through-hole into which a bolt is inserted.

24. The disk drive of claim 21, wherein the thickness of the main chassis is 12.7 mm and the thickness of the pick-up base is 9.7 mm.

25. The disk drive of claim 22, wherein the thickness of the main chassis is 12.7 mm and the thickness of the pick-up base is 9.7 mm.

26. The disk drive of claim 23, wherein the thickness of the main chassis is 12.7 mm and the thickness of the pick-up base is 9.7 mm.
